(19) United States
(12) Patent Application Publication
(10) Pub. No.: US 2012/0003927 A1
(43) Pub. Date: Jan. 5, 2012

(54) Communication Apparatus, Program and Communication Method

(76) Inventor: Masaya Masuda, Fussa-shi (JP)

(21) Appl. No.: 13/154,243

(22) Filed: Jun. 6, 2011

(30) Foreign Application Priority Data
Jun. 30, 2010 (JP) 2010-150441

(51) Int. Cl. H04B 7/24

(52) U.S. Cl. 455/39

(57) ABSTRACT

According to one embodiment, a communication apparatus is provided. The communication apparatus includes: a communication module which is communicatable with a counterpart communication apparatus by a plurality of communication systems and which communicates with the counterpart communication apparatus by at least one of the plurality of communication systems; a communication system determination module which determines a communication system based on a logical connection type established during a communication with the counterpart communication apparatus; and a communication controller which controls the communication module to establish the communication by the determined communication system.

### CROSS REFERENCE TO RELATED APPLICATION(S)

The application is based upon and claims the benefit of priority from Japanese Patent Application No. 2010-150441 filed on Jun. 30, 2010; the entire content of which are incorporated herein by reference.

### FIELD

The present disclosure relates to a communication apparatus, a program and a communication method.

### BACKGROUND

Various communication systems have come into wide use recently with the advance of development of communication technology. In the communication systems, there are lots of communication systems in consideration of communication purposes such as a system allowing communication to be executed with low electric power and a system allowing communication to be executed at a high speed.

When communication apparatuses communicate with each other, for example, for the purpose of exchanging a large amount of data, a communication system allowing communication to be executed at a high speed is preferred. On the other hand, for the purpose of exchanging a small amount of data, the high-speed communication system is not required so much, and, for example, a system in which electric power necessary for communication can be saved is preferred as another communication system than the aforementioned system.

In a certain communication protocol such as Bluetooth (registered trademark), logical connection types are set in accordance with types of data to be exchanged. Since the logical connection types are set in accordance with the types of data to be exchanged, the amounts of data to be exchanged are determined to some degree based on the logical connection types. It is therefore considered that when connection for communication is to be made or is being made, there is a preferred communication system for each logical connection type. However, a communication apparatus which sets a communication system in accordance with each logical connection type has not been provided yet.

### BRIEF DESCRIPTION OF THE DRAWINGS

FIG. 1 is a conceptual view showing an example of a communication system according to a first embodiment.

FIG. 2 is a block diagram showing an example of an internal configuration of a communication apparatus A according to the first embodiment.

FIG. 3 is a conceptual view showing an example of communication systems for the communication apparatus A and a communication apparatus B according to the first embodiment.

FIG. 4 is a conceptual view showing an example of a communication system table according to the first embodiment.

FIG. 5 is a flow chart showing a flow of a communication start process of the communication apparatus A according to the first embodiment.

FIG. 6 is a flow chart showing a flow of a communication start process in the communication apparatus A in the case where a communication start request is received from the communication apparatus B, according to the first embodiment.

FIG. 7 is a block diagram showing an example of an internal configuration of the communication apparatus A according to a second embodiment.

FIG. 8 is a conceptual view showing an example of a communication system table according to the second embodiment.

FIG. 9 is a flow chart showing a flow of a communication start process of the communication apparatus A according to the second embodiment.

FIG. 10 is a flow chart showing a flow of a communication start process in the communication apparatus A when a communication start request is received from the communication apparatus B, according to the second embodiment.

FIG. 11 is a flow chart showing an example of a communication system switching process in the middle of communication in accordance with change in the status of a power supply of the communication apparatus A, according to the second embodiment.

### DETAILED DESCRIPTION

In general, according to one exemplary embodiment, a communication apparatus is provided. The communication apparatus includes: a communication module which is communicatable with a counterpart communication apparatus by a plurality of communication systems and which communicates with the counterpart communication apparatus by at least one of the plurality of communication systems; a communication system determination module which determines a communication system based on a logical connection type established during a communication with the counterpart communication apparatus; and a communication controller which controls the communication module to establish the communication by the determined communication system.

Embodiments will be described below with reference to the drawings.

### First Embodiment

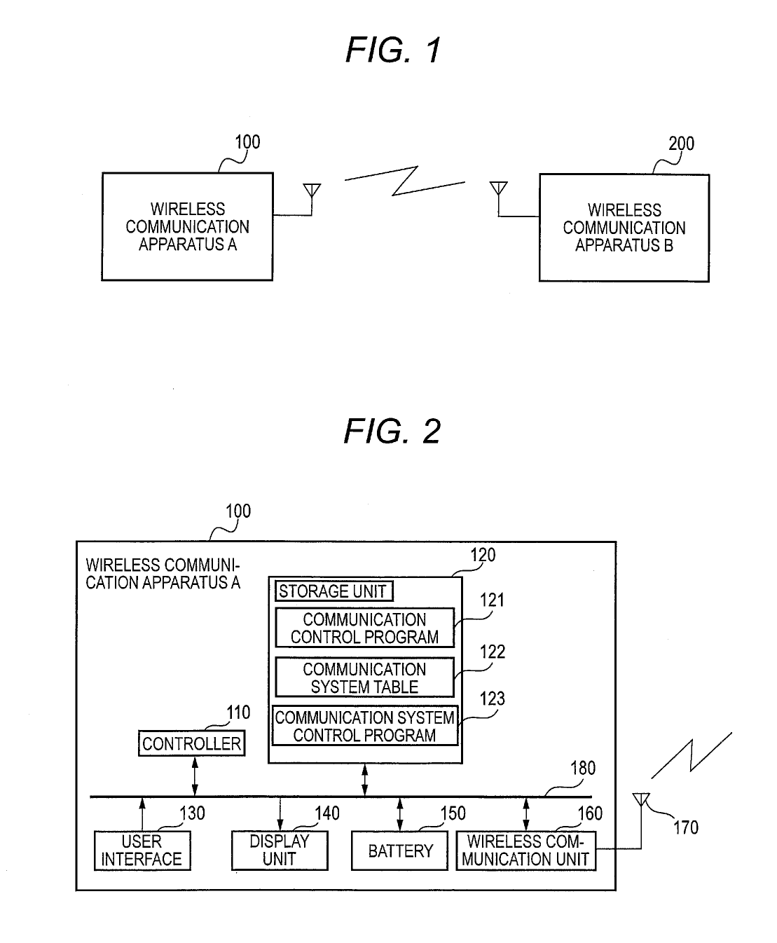

First, a first embodiment will be described with reference to FIGS. 1 to 6.

FIG. 1 is a conceptual view showing an example of a communication system 1 according to the first embodiment. A communication apparatus A 100 and a communication apparatus B 200 are shown in FIG. 1.

The communication apparatus A 100 and the communication apparatus B 200 execute wireless communication with each other. In the embodiment, the communication is executed, for example, based on a Bluetooth communication protocol.

FIG. 2 is a block diagram showing an example of an internal configuration of the communication apparatus A 100 according to the embodiment.

The communication apparatus A 100 includes a controller 110, a storage unit 120, a user interface 130, a display unit 140, a battery 150, a communication unit 160, an antenna 170, and a bus 180.

For example, the controller 110 is a Central Processing Unit (CPU) generally controlling the communication apparatus A 100. The controller 110 has a function of executing certain processing in accordance with programs stored in the storage unit 120.

For example, the storage unit 120 is a semiconductor storage device. The storage unit 120 stores various kinds of programs to be executed by the controller 110, various kinds of information required for certain processing, various kinds of data files, etc. (storage unit). In addition, the storage unit 120 stores a communication control program 121, a communication system table 122, and a communication system control program 123. The controller 110 executes the communication control program 121 and the communication system control program 123 to execute predetermined processing, and refers to the communication system table 122 on this occasion. These will be described later.

The user interface 130 is an operation input unit such as a keyword, a touchscreen, etc. on which a user can gives an operation to the communication apparatus A 100. The user interface 130 inputs a user's operation as an electric signal into the communication apparatus A 100. Although a keyboard, a touchscreen, etc. are used as examples of the user interface 130 in the embodiment, the user interface 130 is not limited thereto. For example, the user interface 130 may include a signal receiving unit etc. for receiving a signal from an external remote controller on which the user gives an operation.

The display unit 140 is a display device such as a liquid crystal display or a self-emission type display. The display unit 140 has a function of displaying an image.

For example, the battery 150 is a storage battery which has a function of storing supplied electric power. The communication apparatus A 100 is driven by the battery 150.

The wireless communication unit 160 serves as a communication unit which transmits/receives radio waves through the antenna 170 and executes wireless communication with a counterpart communication apparatus (e.g. the communication apparatus B 200).

The bus 180 has a function of connecting each of the connected units inside the communication apparatus A 100 so that the units can communicate with one another.

In the embodiment, the communication apparatus A 100 and the communication apparatus B 200 execute wireless communication with each other. In the embodiment, the communication apparatus B 200 is regarded as an apparatus having the same internal configuration as that of the communication apparatus A 100 so that description about the internal configuration of the communication apparatus B 200 is omitted here. However, the embodiment is however not limited thereto. The communication apparatus device B 200 need not have the same internal configuration as the communication apparatus A 100 as long as the communication apparatus B 200 can execute wireless communication with the communication apparatus A 100.

In the embodiment, the communication apparatus A 100 and the communication apparatus B 200 execute wireless communication with each other based on the Bluetooth standard. However, the embodiment is not limited thereto. The communication may be executed based on another communication standard.

Communication specifications (communication systems) can be added by version upgrading of the Bluetooth standard. In addition to a Basic Rate (BR)/Enhanced Data Rate (EDR) communication specification (communication system) up to Bluetooth v.2.0+EDR, Alternate MAC/PHY (AMP) which makes higher-speed communication than BR/EDR possible but requires higher power consumption than BR/EDR has been introduced in Bluetooth v.3.0+HS. Moreover, a communication specification (communication system) called Low Energy (LE) which can obtain lower power consumption than BR/EDR in exchange for lower communication speed than BR/EDR has been introduced in Bluetooth v.4.0. In the Bluetooth standard, details of functions and procedures essential for mutual connection have been defined but details of others except a framework have not been defined so as to depend on mounting. Accordingly, a processing procedure on the standard for switching the communication specifications (communication systems) from one to another is not defined particularly. In the embodiment, BR/EDR, AMP and LE are employed as specific examples of the communication systems. Note that BR/EDR, AMP and LE are collectively called Bluetooth traffic bearers.

The communication apparatus A 100 starts communication with the communication apparatus B 200 automatically or based on a user's operation from the user interface 130. On this occasion, the controller 110 executes the communication control program 121 stored in the storage unit 120 to control the communication. The wireless communication unit 160 executes wireless communication under the communication control of the controller 110.

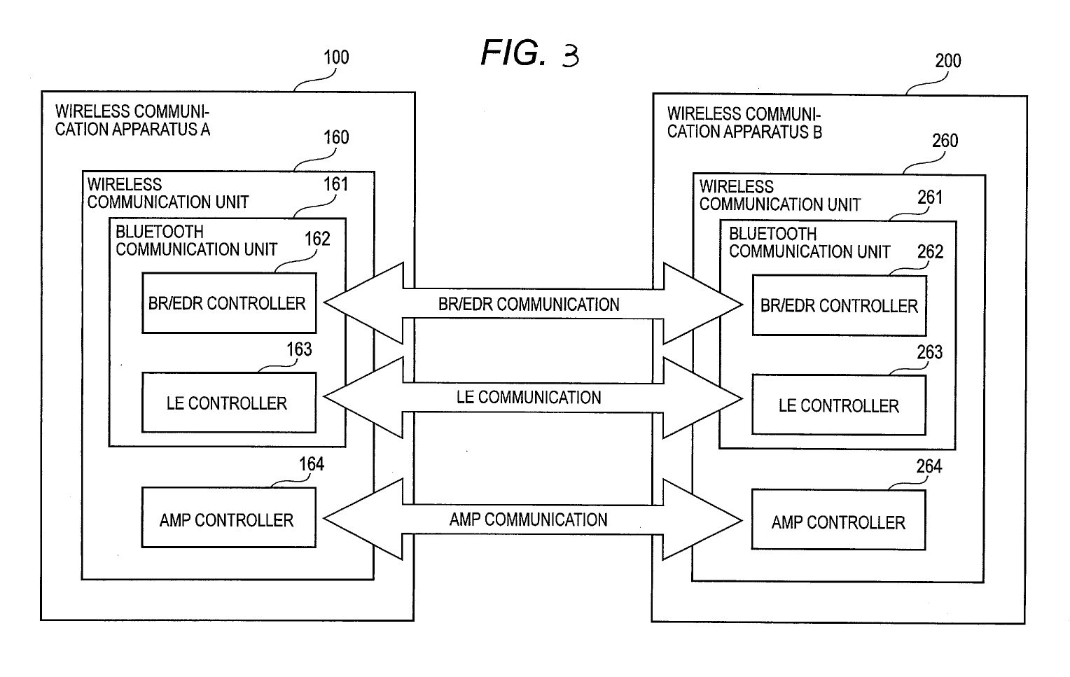

Next, a communication system will be described with reference to FIG. 3.

FIG. 3 is a conceptual view showing an example of communication systems for the communication apparatus A 100 and the communication apparatus B 200, according to the embodiment.

The wireless communication unit 160 of the communication apparatus A 100 has a Bluetooth communication unit 161.

The Bluetooth communication unit 161 is a communication unit for executing communication based on the Bluetooth standard. The Bluetooth communication unit 161 has a BR/EDR controller 162, and an LE controller 163.

The BR/EDR controller 163 is a communication controller which operates based on the Basic Rate (BR) and Enhanced Data Rate (EDR) communication specification (communication system) defined by Bluetooth v.2.0+EDR.

The LE controller 163 is a communication controller which operates based on the LE communication specification (communication system) defined by Bluetooth v.4.0.

In addition, the wireless communication unit 160 has an AMP controller 164.

The AMP controller 164 is a communication controller which operates based on the AMP communication specification (communication method) defined by Bluetooth v.3.0+HS. The AMP is a general framework for using MAC/PHY another wireless communication system than the Bluetooth. For example, wireless communication based on IEEE802.11 (a/b/g) etc. is an example of the AMP. When communication is executed based on the AMP, communication of the AMP controller 164 is controlled while the Bluetooth communication unit 161 is controlled.

The communication apparatus B 200 also has the same configuration as the communication apparatus A 100. Therefore, the communication apparatus A 100 and the communication apparatus B 200 can execute Bluetooth communication based on the BR/EDR, AMP and LE (Bluetooth traffic bearers) communication specifications (communication systems). In addition, the communication apparatus A 100 and the communication apparatus B 200 can establish the aforementioned three communication specifications (communication systems) simultaneously or selectively. For example, BR/EDR, AMP and LE communications can be established either one by one separately or simultaneously. Further, one of the three communication specifications may not be established while the other two communication specifications are established simultaneously.

Although the embodiment has been described in the configuration where the number of communication systems between the communication apparatus A 100 and the communication apparatus B 200 is three (i.e. BR/EDR, AMP and LE), the communication systems are not limited thereto. As long as a plurality of communication systems are used, the number of communication systems may be smaller than three or may be larger than three.

In a communication protocol, logical connection types may be determined in accordance with types of data to be exchanged. For example, in the Bluetooth communication, specifications called profiles which define protocols used in accordance with purposes of communication and types of devices and behaviors of application layers are determined based on standardization. Examples of profiles in the Bluetooth communication include Audio/Video Remote Control Profile (AVRCP) for controlling a remote device, Advanced Audio Distribution Profile (A2DP) as a profile for transmitting/receiving high-quality audio data, Serial Port Profile (SPP) as a profile for setting a device as a virtual serial port, etc. In each profile, logical connection types based on types of data to be transmitted are determined based on standardization. For example, A2DP (Signaling) for executing connection to a remote device and some sort of configurations, A2DP (Media) for exchanging audio data etc., and the like are defined as logical connection types in the A2DP. When communication is executed based on the A2DP (Signaling) in the A2DP profile, it is conceived that a communication system of low power consumption is preferred to high-speed communication because the quantity of data to be exchanged may be often so small that a high-speed communication system is not required so much. On the other hand, in A2DP (Media), it is conceived that a high-speed communication system is preferred because audio data are exchanged so that the quantity of data becomes large.

The communication apparatus A 100 in the embodiment can execute communication with the communication apparatus B 200 based on a communication system suitable for a logical connection type.

In the communication apparatus A 100, when the controller 110 executes the communication control program 121 to control start of communication, the controller 110 also executes the communication system control program 123 to determine a system of communication with the communication apparatus B 200. Determination of the communication system can be made by referring to the communication system table 122.

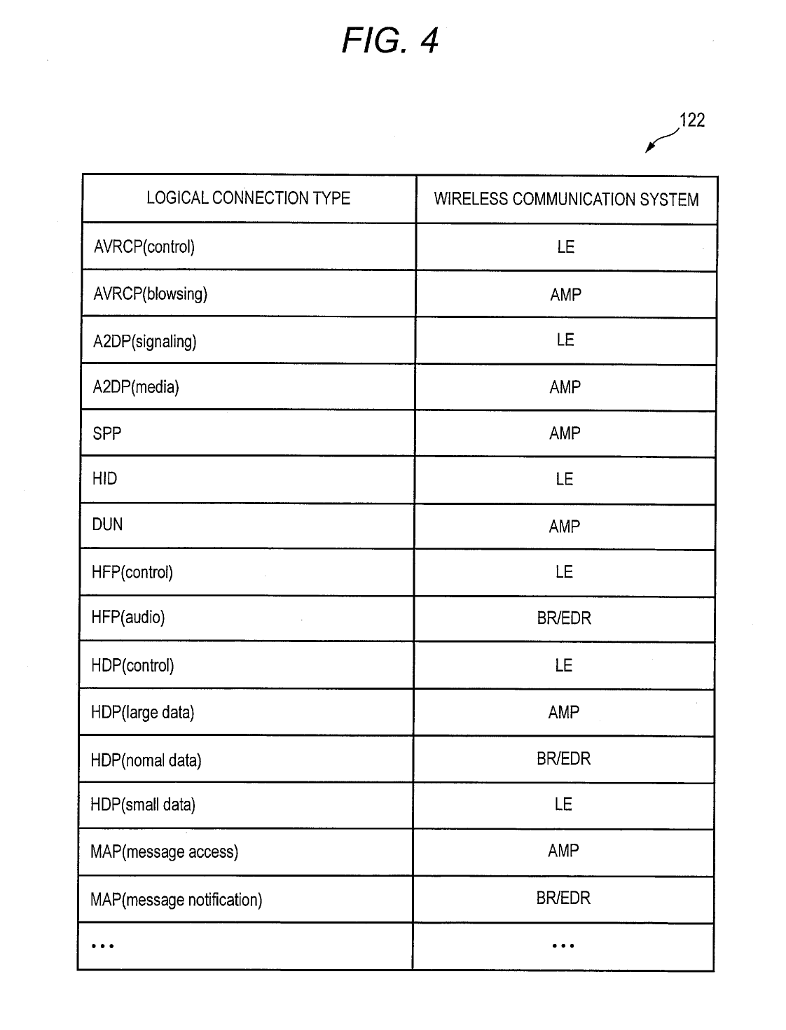

FIG. 4 is a conceptual view showing an example of the communication system table 122 according to the embodiment.

In the communication system table 122, communication systems are made in correspondence with logical connection types. The controller 110 detects a communication logical connection type during communication (logical connection type detection unit), and refers to the communication system table 122 to thereby determine a communication system corresponding to the logical connection type as a communication system used on this occasion.

In the communication system table 122, communication systems are made in correspondence with logical connection types. For example, a communication system of high transmission speed is assigned to a logical connection type which is conceived to be generally large in data transmission quantity or a logical connection type which requires high transmission speed. In the communication system table 122, a communication system of lower transmission speed but lower power consumption is assigned to a logical connection type which is conceived to be generally small in data transmission quantity or a logical connection type which does not require high transmission speed.

As described above, communication based on the AMP can be executed at a high speed but with high power consumption compared with communication based on the BR/EDR. On the other hand, communication based on the LE is executed with low power consumption but at a slow communication speed compared with communication based on the BR/EDR. In the communication system table 122 in the embodiment, the AMP higher in transmission speed than the BR/EDR is assigned to a logical connection type for which high speed transmission is conceived to be suitable, and the LE lower in power consumption than the BR/EDR is assigned to a logical connection type which does not require high-speed communication so much.

Next, a communication start process in the embodiment will be described.

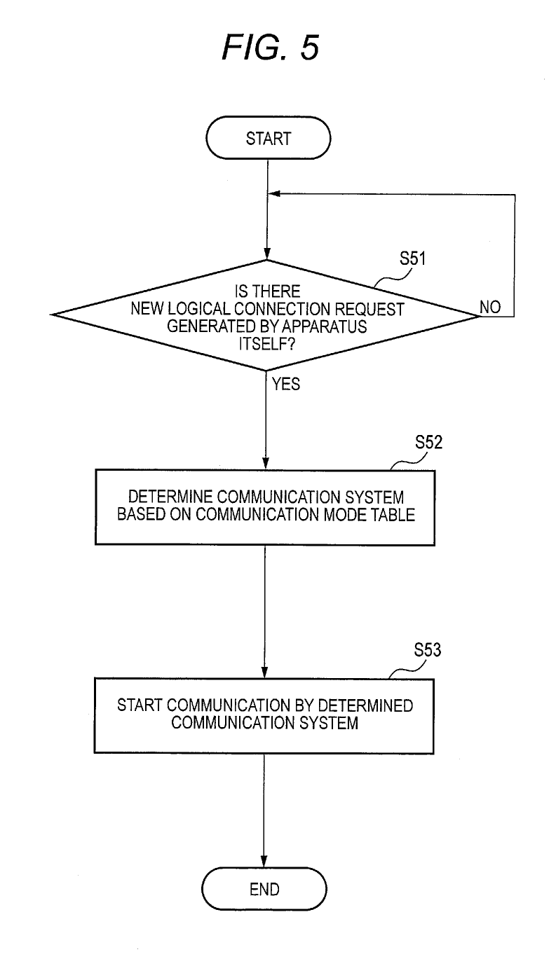

FIG. 5 is a flow chart showing a flow of the communication start process of the communication apparatus A 100 in the embodiment.

First, the controller 110 of the communication apparatus A 100 detects whether a new logical connection request is generated by the communication apparatus A 100 or not, for example, through the user interface 130 etc. (step S51).

In the step S51, when there is no new logical connection request generated (No in the step S51), the processing flow goes back to the step S51 again.

In the step S51, when a new logical connection request is generated (Yes in the step S51), the controller 110 executes the communication control program 121 to serve as a communication controller to control communication concerned with the logical connection request. On this occasion, the controller 110 further executes the communication system control program 123 to determine a logical connection type indicated by the new logical connection request. Further, the controller 110 refers to the communication system table 122, and serves as a communication system determination unit to determine a communication system corresponding to the logical connection type indicated by the new logical connection request (step S52).

When the communication system is determined, the controller 110 controls the wireless communication unit 160 so that the communication apparatus A 100 starts communication with the communication apparatus B 200 based on the determined communication system (step S53).

After the steps have been executed as described above, the flow of the communication start process based on the new logical connection request generated by the communication apparatus A 100 itself is completed.

Although the communication apparatus A 100 may start communication due to a request generated by the communication apparatus A 100 itself, the communication apparatus A 100 can also start communication due to a communication start request given from another communication apparatus. Description will be made below on a flow of a communication start process of the communication apparatus A 100 when a communication start request is given from the communication apparatus B 200.

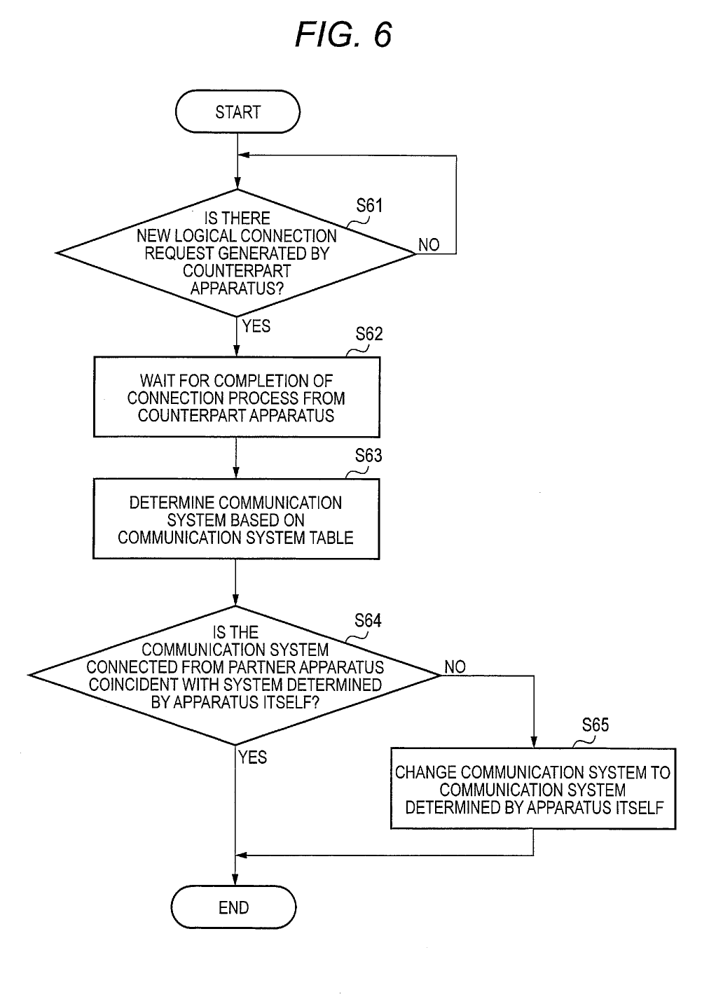

FIG. 6 is a flow chart showing the flow of the communication start process in the communication apparatus A 100 when a communication start request is received from the communication apparatus B 200 according to the embodiment.

First, the controller 110 of the communication apparatus A 100 detects whether a new logical connection request is generated by the communication apparatus B 200 or not (step S61).

In the step S61, when there is no new logical connection request generated (No in the step S61), the processing flow goes back to the step S61 again.

In the step S61, when generation of a new logical connection request is detected (Yes in the step S61), the controller 110 waits for completion of a communication connection process requested by the communication apparatus B 200 (step S62). That is, the communication apparatus A 100 establishes communication once based on a communication system requested by the communication apparatus B 200.

Then, the controller 110 refers to the communication system table 122 in the same manner as described above to thereby determine a communication system based on the new logical connection request given from the communication apparatus B 200 (step S63).

Then, the controller 110 uses the communication system control program 123 to determine whether the communication system determined in the step S63 is coincident with the communication system connected from the communication apparatus B 200 or not (step S64).

When the communication system determined in the step S63 is coincident with the communication system connected from the communication apparatus B 200 (Yes in the step S64), the controller 110 sustains the established connection.

When the communication system determined in the step S63 is different from (not coincident with) the communication system connected from the communication apparatus B 200 (No in the step S64), the controller 110 controls the wireless communication unit 160 to change the communication system. That is, the controller 110 changes the communication system connected from the communication apparatus B 200 to the communication system determined by the communication apparatus A 100 itself, and then starts communication (Step S65).

After the steps have been executed as described above, the flow of the communication start process based on the new logical connection request generated by the communication apparatus B 200 is completed.

As described above, when the communication apparatus A 100 in the embodiment executes communication with the communication apparatus B 200 based on a new logical connection type, the communication apparatus A 100 determines a communication system based on the logical connection type and then executes communication with the communication apparatus B 200. Therefore, the communication apparatus A 100 can execute communication with the communication apparatus B 200 by a communication system suitable in accordance with each logical connection type.

In addition, the communication apparatus in the embodiment can control communication systems allowed to be used in one communication standard based on logical connection types contained in this standard. In other words, the communication apparatus in the embodiment need not switch the communication system to a communication system entirely controlled by another communication standard when the communication system is determined or changed.

Next, a second embodiment will be described.

### Second Embodiment

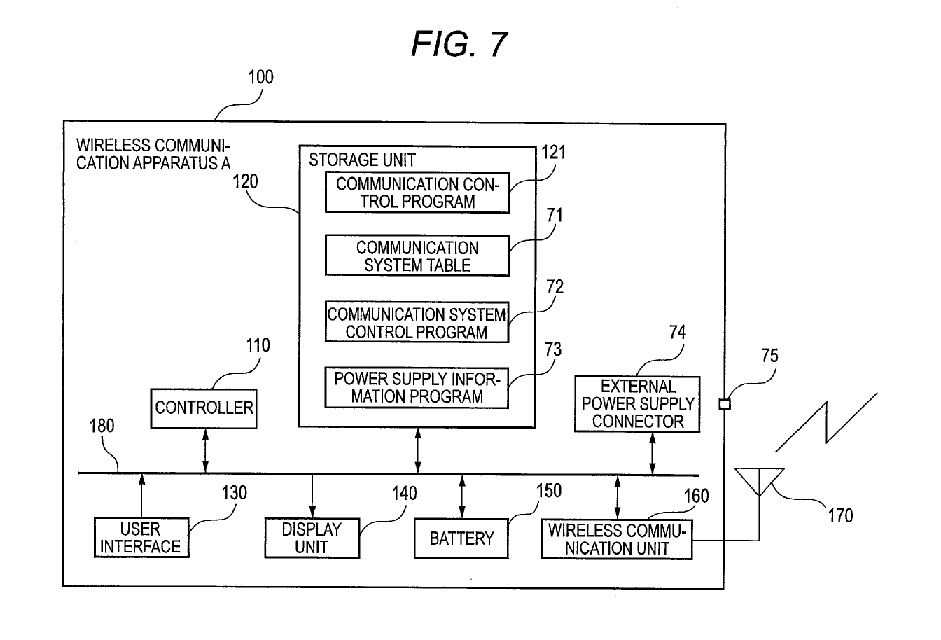

The second embodiment will be described below with reference to FIGS. 7 to 11.

FIG. 7 is a block diagram showing an example of an internal configuration of a communication apparatus A 100 in the embodiment.

Constituent members of the embodiment substantially the same in function etc. as those of the first embodiment are referred to by the same names and numerals as those of the first embodiment, and the embodiment will be described below. In addition, description of the same functions of these constituent members as in the first embodiment will be omitted hereunder.

The communication apparatus A 100 in the embodiment is shown in FIG. 7. A communication system table 71, a communication system control program 72, a power supply information program 73 and an external power supply connector 74 are shown as constituent members largely different in function etc. from those in the first embodiment and constituent members not shown in the first embodiment.

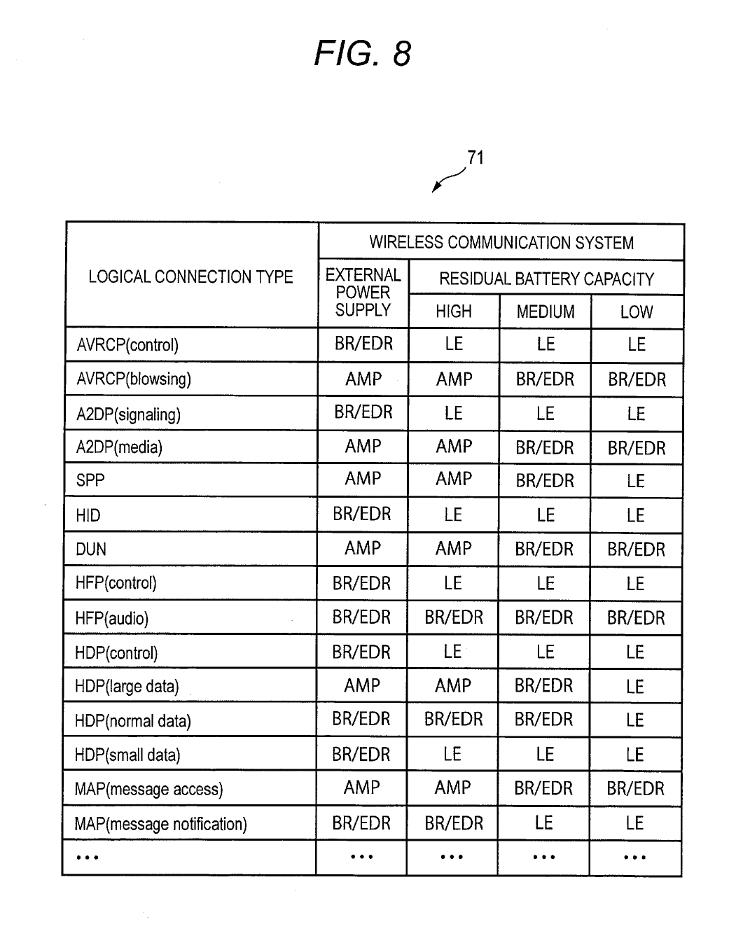

Communication systems corresponding to combinations of logical connection type and power supply information used as indices are shown in the communication system table 71. The power supply information mentioned herein includes information as to whether electric power is being supplied by an external power supply or not, and information about the residual battery capacity (residual storage capacity) of the battery 150 when the communication apparatus A 100 is not supplied with electric power from an external power supply but is driven by the battery 150. Details will be described later with reference to FIG. 8.

The communication system control program 72 is a program for determining a communication system based on the logical connection type and the power supply information by referring to the communication system table 71. The controller 110 determines a communication system during communication by executing the communication system control program 72.

The power supply information program 73 is a program for acquiring power supply information. The controller 110 executes the power supply information program 73 so as to be able to serve as a power supply information reception unit to acquire (receive) information as to whether electric power is being supplied by an external power supply or not, and information about the residual battery capacity (residual storage capacity) of the battery 150.

The external power supply connector 74 is a connector which can be connected to an external power supply outside the communication apparatus A 100 through a terminal 75 and which has a function of supplying electric power fed from the outside to the whole of the communication apparatus A 100.

The communication system table 71 will be described below.

FIG. 8 is a conceptual view showing an example of the communication system table 71 in the embodiment.

In the communication system table 71, combinations of logical connection type and power supply information are made in correspondence with communication systems. The controller 110 acquires the logical connection type of communication during communication and the power supply information at that time and determines a communication system by referring to the communication system table 71.

When, for example, the communication apparatus A 100 is being supplied with electric power from an external power supply (e.g. plugged in a wall socket or the like), the controller 110 uses BR/EDR or AMP as a communication system to transmit/receive communication data at a high speed because there is no fear that the residual battery capacity of the battery 150 will run too short to use the communication apparatus A 100. On the other hand, when the communication apparatus A 100 is not supplied with electric power from an external power supply, the communication apparatus A 100 determines a communication system in accordance with the residual battery capacity of the battery 150. When the residual battery capacity is high, the communication apparatus A 100 heavily uses BR/EDR or AMP to execute communication at a high speed. When the residual battery capacity is low, the communication apparatus A 100 heavily uses LE to reduce power consumption for communication. In the communication system table 71 in the embodiment, numerical values are predetermined so that the communication apparatus A 100 can execute power supply control as described above.

A communication start process of the communication apparatus A 100 in the embodiment will be described below.

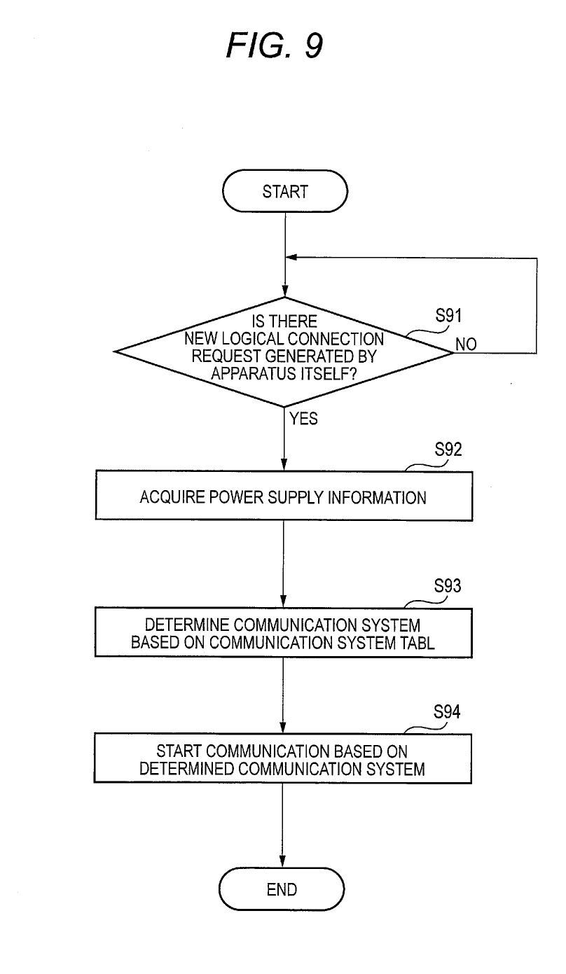

FIG. 9 is a flow chart showing a flow of the communication start process of the communication apparatus A 100 in the embodiment.

First, the controller 110 of the communication apparatus A 100 detects whether a new logical connection request is generated by the communication apparatus A 100 itself or not, for example, through the user interface 130, etc. (step S91).

In the step S91, when there is no new logical connection request generated (No in the step S91), the processing flow goes back to the step S91 again.

In the step S91, when there is a new logical connection request generated (Yes in the step S91), the controller 110 executes the communication control program 121 so as to serve as a communication controller to control communication concerned with the logical connection request. On this occasion, the controller 110 further executes the power supply information program 73 so as to serve as a power supply information reception unit to receive (acquire) power supply information (step S92). That is, the controller 110 first detects whether the external power supply connector 74 is connected to an external power supply or not. When the external power supply connector 74 is not connected to any external power supply, the controller 110 acquires information about the residual battery capacity of the battery 150. In the embodiment, the residual battery capacity on this occasion is classified into three categories, that is, “high”, “medium” and “low” in use.

Then, the controller 110 executes the communication system control program 72 to determine a logical connection type indicated by the new logical connection request. The controller 110 refers to the communication system table 71, and serves as a communication system determination unit to determine a communication system corresponding to the new combination of the logical connection type and the power supply information (step S93).

When the communication system is determined, the controller 110 controls the wireless communication unit 160 so that the communication apparatus A 100 starts communication with the communication apparatus B 200 by the determined communication system (step S94).

After the steps have been executed as described above, the flow of the communication start process based on the new logical connection request generated by the communication apparatus A 100 itself is completed.

Although the communication apparatus A 100 in this embodiment may start communication due to a request generated by the communication apparatus A 100 itself in the same manner as in the first embodiment, the communication apparatus A 100 can also start communication due to a communication start request given form another communication apparatus. Description will be made below on a flow of a communication start process of the communication apparatus A 100 when a communication start request is given from the communication apparatus B 200.

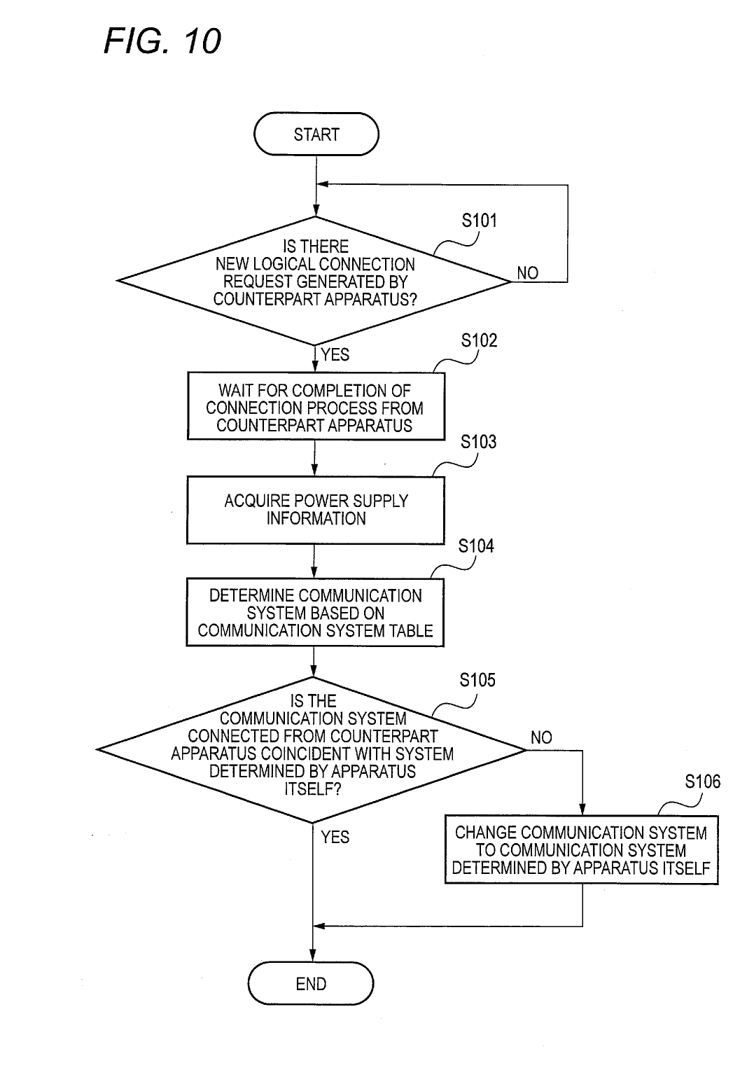

FIG. 10 is a flow chart showing the flow of the communication start process in the communication apparatus A 100 when a communication start request is received from the communication apparatus B 200 in the embodiment.

First, the controller 110 of the communication apparatus A 100 detects whether a new logical connection request is generated by the communication apparatus B 200 or not (step S101).

In the step 5101, when there is no new logical connection request generated (No in the step S101), the processing flow goes back to the step S101 again.

In the step S101, when generation of a new logical connection request is detected (Yes in the step S101), the controller 110 waits for completion of a communication connection process from the communication apparatus B 200 (step S102). That is, the communication apparatus A 100 establishes communication once by a communication system requested by the communication apparatus B 200.

Then, the controller 110 acquires power supply information (step S103).

After completion of the step S103, the controller 110 refers to the communication system table 71 to determine a communication system based on the new logical connection request given from the communication apparatus B 200 and the power supply information of the communication apparatus A 100 itself in the same manner as described above (step S104).

Then, the controller 110 uses the communication system control program 72 to determine whether the communication system determined in the step S104 is coincident with the communication system connected from the communication apparatus B 200 or not (step S105).

When the communication system determined in the step S104 is coincident with the communication system connected from the communication apparatus B 200 (Yes in the step S105), the controller 110 sustains the established connection.

When the communication system determined in the step S104 is not coincident with the communication system connected from the communication apparatus B 200 (No in the step S105), the controller 110 controls the wireless communication unit 160 to change the communication system. That is, the controller 110 changes the communication system connected from the communication apparatus B 200 to the communication system determined by the communication apparatus A 100 itself, and then starts communication (step S106).

After the steps have been executed as described above, the flow of the communication start process based on the new logical connection request given from the communication apparatus B 200 is completed.

Next, a communication system switching process in the middle of communication in accordance with change in the status of a power supply of the communication apparatus A 100 will be described.

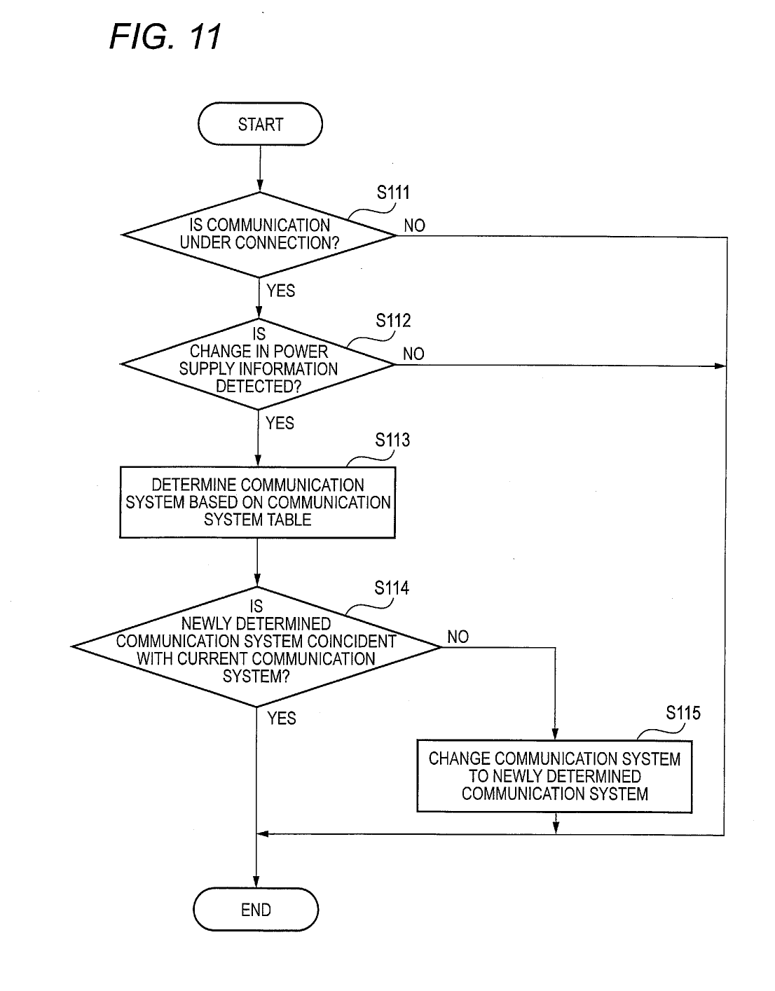

FIG. 11 is a flow chart showing an example of a communication system switching process in the middle of communication in accordance with change in the status of a power supply of the communication apparatus A 100 according to the embodiment.

First, when the communication apparatus A 100 is under communication (Yes in Step S111), the controller 110 uses the power supply information acquisition program 73 to detect change in power supply information (step S112). For example, power supply information may change when the communication apparatus A 100 was supplied with electric power from an external power supply but the external power supply connector 74 has been disconnected from the external power supply so that the power supply source of the communication apparatus A 100 has been switched to the battery 150. In addition, it is conceivable that power supply information changes when the residual battery capacity of the battery 150 is reduced from “high” to “medium” beyond a threshold. Further, it is conceivable as a typical instance that power supply information changes when the power supply which is being used is switched from the battery 150 to an external power supply while the communication apparatus A 100 connected to the external power supply is driven by the battery 150.

In the step S112, when the controller 110 detects the change in power supply information (Yes in the step S112), the controller 110 refers to the communication system table 71 to determine a communication system to be used, based on the changed power supply information (step S113).

When the communication system is determined in the step S113, the controller 110 determines whether the communication system newly determined in the step S113 is coincident with the currently executed communication system or not (step S114).

In the step S114, when the controller 110 determines that the newly determined communication system is not coincident with the currently executed communication system (No in the step S114), the controller 110 switches the communication system from the currently executed communication system to the communication system newly determined in the step S113 (step S115).

When the communication apparatus A 100 is not under communication in the step S111 (No in the step S111), when there is no detection of change in power supply information in the step S112 (No in the step S112), when the communication system newly determined in the step S113 is coincident with the currently executed communication system (Yes in the step S114), or after completion of the step S115, the series of processing flow is terminated.

In the embodiment, since power supply information is detected, a communication system can be determined based on a combination of logical connection type and the power supply information. In other words, communication can be executed by a communication system suitable for the status of a power supply during communication. When the residual battery capacity of the battery 150 is low, communication is executed by a communication system low in power consumption. When the power supply which can be used has enough power (when the communication apparatus A 100 is connected to an external power supply or when the residual battery capacity of the battery 150 is high), high-speed communication can be executed.

Although the logical connection type is expressed as a subordinate concept of a profile in the embodiment, the embodiment is not limited thereto. For example, a profile per se may be used as the logical connection type. The respective constituent members in the embodiment may be implemented either as software or as hardware.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication module configured to be communicatable with a counterpart communication apparatus by a plurality of communication systems and to communicate with the counterpart communication apparatus by at least one of the plurality of communication systems;
a communication system determination module configured to determine a communication system based on a logical connection type established during a communication with the counterpart communication apparatus; and
a communication controller configured to control the communication module to establish the communication by the determined communication system.

2. The apparatus of claim 1 further comprising:
a storage configured to store a first communication system table indicating a correspondence between the logical connection type and the communication system,
wherein the communication system determination module is configured to determine the communication system based on the correspondence.

3. The apparatus of claim 2 further comprising:
a logical connection type detection module configured to detect the logical connection type,
wherein the communication system determination module is configured to determine the communication system based on the detected logical connection type.

4. The apparatus of claim 1, wherein the communication system determination module is configured to determine the communication system based on a combination of power supply information of the communication apparatus and the logical connection type.

5. The apparatus of claim 4 further comprising:
a storage module configured to store a second communication system table indicating correspondence between the combination of power supply information of the communication apparatus, and the logical connection type and the communication system,
wherein the communication system determination module is configured to determine the communication system based on the correspondence.

6. The apparatus of claim 4 further comprising:
a power supply information receiver configured to receive the power supply information,
wherein the communication system determination module is configured to determine the communication system based on the power supply information.

7. The apparatus of claim 1, wherein, when the communication system determination module determines a second communication system different from a first communication system currently established by the communication module, the communication controller is configured to change the communication system from the first communication system to the second communication system.

8. The apparatus of claim 7, wherein the communication system determination module is configured to determine the communication system when there is given a request to change the logical connection type from a first logical connection type of currently executed communication to a second logical connection type different from the first logical connection type.

9. The apparatus of claim 4, wherein, when the communication system determination module determines a second communication system different from a first communication system currently established by the communication module based on a change in the power supply information, the communication controller is configured to change the communication system from the first communication system to the second communication system.

10. A program executed by a communication apparatus, comprising:
making a communication module which uses a plurality of communication systems for communicating with a counterpart communication apparatus, communicate with the counterpart communication apparatus by using at least one of the plurality of communication systems;
making a communication system determination module determine a communication system based on a logical connection type established during a communication with the counterpart apparatus; and
making a controller control the communication module to establish the communication by the communication system.

11. A communication method executed by a communication apparatus which uses a plurality of communication systems for communicating with a counterpart communication apparatus, the method comprising:
making a communication module communicate with the counterpart communication apparatus by using at least one of the plurality of communication systems;
determining a communication system based on a logical connection type established during a communication with the other communication apparatus; and
controlling the communication module to establish the communication by the determined communication system.
